(19) United States
(12) Patent Application Publication
(10) Pub. No.: US 2011/0047844 A1
(43) Pub. Date: Mar. 3, 2011

(54) MERCHANDISE DISPLAY STAND AND REMOVABLE LABEL HOLDER

(75) Inventors: Christopher J. Fawcett, Charlotte, NC (US); Nicholas M. Sedon, Weddington, NC (US)

(73) Assignee: INVUE SECURITY PRODUCTS INC., Charlotte, NC (US)

(21) Appl. No.: 12/552,031

(22) Filed: Sep. 1, 2009

(51) Int. Cl. G09F 3/18; G08B 13/14

(52) U.S. Cl. 40/642.02; 340/572.1

(57) ABSTRACT

A merchandise display stand for displaying an item of merchandise includes a base and a sensor housing coupled to the base. The sensor housing includes a mounting surface for receiving the item of merchandise and attachment means for affixing the item of merchandise to the mounting surface. A label holder is configured to be removably mounted on the base and prevented from being removed from the base with the item of merchandise affixed to the sensor housing. The label holder includes a mounting portion and a label holding portion extending from the mounting portion. The base has an exterior contour and the mounting portion of the label holder has a complimentary interior contour defining an opening for receiving the base. The opening is sized smaller than an outer periphery of the item of merchandise affixed to the sensor housing such that the label holder cannot be removed from the display stand with the label holder mounted on the display stand and the item of merchandise affixed to the sensor housing

### BACKGROUND OF THE INVENTION

The present invention relates generally to merchandise display stands for displaying an item of merchandise. More particularly, the invention relates to a merchandise display stand and a removable label holder for use with the display stand. In a preferred embodiment, the label holder is configured to be removably mounted on the merchandise display stand and prevented from being removed from the display stand while the item of merchandise is affixed to the display stand.

Merchandise display stands are commonly utilized in retail stores to display an item of merchandise, such as a mobile (e.g. cellular) telephone, camera, digital video recorder (DVR), personal digital assistant (PDA) and the like. The display stand permits a customer to examine, and in many instances, manipulate the merchandise prior to purchasing the item. In order to deter theft, the merchandise may be secured to the display stand by a mechanical tether, such as a cable or cord. Alternatively, or in addition, the display stand may include an electrical sensor operatively coupled to a monitoring circuit that activates an alarm if the merchandise is separated from the display stand or the tether is severed. Such merchandise display stands are well known and are commercially available from InVue Security Products, Inc. of Charlotte, N.C.

In many instances, it is desirable to provide the potential purchaser with visual information regarding the merchandise, such as a product name, price, description or barcode identifier. The information may be imprinted onto the display stand itself. However, it is typically necessary for the retailer to utilize the same merchandise display stand with different types of products, or with different versions of the same type of product. As a result, it is desirable to attach a label holder to the display stand that is configured to receive a label having the printed information. It is preferred that the label holder, or at least the label, be removable from the display stand to allow store personnel to quickly interchange merchandise and labels. Unfortunately, a removable label holder or label provides shoplifters and other individuals having malicious intent with the opportunity to exchange a label from one display stand with a label from another or to remove the label from the display stand in an attempt to deceive store personnel as to the correct price of an item, or to simply disrupt the business of the retailer.

Accordingly, there exists an unresolved need for an improved merchandise display stand and a removable label holder for use with a display stand. There exists a further need for a removable label holder that is configured to be mounted on a merchandise display stand and prevented from being removed from the display stand while the merchandise is affixed to the display stand.

### BRIEF SUMMARY OF THE INVENTION

The aforementioned needs, objectives and advantages, as well as others that will be readily apparent to those of ordinary skill in the art, are provided by a merchandise display stand and a removable label holder according to the present invention.

In one aspect, the invention is embodied by a merchandise display stand for displaying an item of merchandise including a base and a label holder removably mounted on the base. The label holder has a mounting portion for mounting the label holder on the base and a label holding portion. The label holder is configured such that the label holder is prevented from being removed from the base while the item of merchandise is displayed on the display stand.

In preferred embodiments, the base has an exterior contour and the mounting portion of the label holder has an interior contour defining an opening configured to receive the base. The interior contour of the mounting portion conforms generally to the exterior contour of the base such that the label holder is slidably mounted on the base.

In other preferred embodiments, the merchandise display stand further includes a sensor housing coupled to the base. The sensor housing includes a mounting surface for receiving the item of merchandise and attachment means for affixing the item of merchandise to the mounting surface of the sensor housing.

In other preferred embodiments, the base includes an upright portion for supporting the sensor housing and the opening defined by the mounting portion of the label holder is configured to pass over the sensor housing and to be received on the upright portion of the base without the item of merchandise affixed to the sensor housing.

In other preferred embodiments, the sensor housing houses a proximity sensor having a secured state and an unsecured state. The proximity sensor is in the secured state with the item of merchandise affixed to the sensor housing and is in the unsecured state without the item of merchandise affixed to the sensor housing.

In other preferred embodiments, the merchandise display stand further includes an alarm operatively coupled to the proximity sensor. The alarm has an unarmed state and an armed state for monitoring the secured state and the unsecured state of the proximity sensor.

In another aspect, the invention is embodied by a merchandise display stand for displaying an item of merchandise. The display stand includes a base and a sensor housing coupled to the base. The sensor housing includes a mounting surface for receiving the item of merchandise and attachment means for affixing the item of merchandise to the mounting surface. A label holder is configured to be removably mounted on the base and prevented from being removed from the base with the item of merchandise affixed to the sensor housing.

In another aspect, the invention is embodied by a label holder for removably mounting on a base of a display stand. The label holder including a mounting portion having an interior contour that defines an opening for receiving the base of the display stand and a label holding portion extending from the mounting portion. The mounting portion is configured to be removably mounted on the display stand without an item of merchandise displayed on the display stand and cannot be removed from the display stand with an item of merchandise displayed on the display stand.

In preferred embodiments, the base has an exterior contour and the mounting portion of the label holder has a complimentary interior contour defining an opening that conforms generally to the exterior contour of the base such that the label holder is slidably mounted on the base.

In other preferred embodiments, the opening defined by the mounting portion is sized smaller than an outer periphery of an item of merchandise affixed to the display stand such that the label holder cannot be removed from the display stand with the label holder mounted on the display stand and the item of merchandise affixed to the display stand.

In another aspect, the invention is embodied by an item of merchandise in combination with a merchandise display stand for displaying the item of merchandise and a removable label holder. The merchandise display stand including a base and a sensor housing movably attached to the base. The label holder being configured to be removably mounted on the base of the display stand. The item of merchandise being configured to be affixed to the sensor housing. The label holder being prevented from being removed from the base of the display stand when the label holder is mounted on the base and the item of merchandise is affixed to the sensor housing.

In preferred embodiments, the base of the display stand has an exterior contour and the label holder has an interior contour that generally conforms to the exterior contour of the base.

In other preferred embodiments, the label holder includes a mounting portion and a label holding portion extending outwardly from the mounting portion, and the mounting portion defines an opening sized to receive the base of the display stand. The opening is sized larger than an outer periphery of the sensor housing and is sized smaller than an outer periphery of the item of merchandise.

In other preferred embodiments, the sensor housing houses a proximity sensor having a secured state with the item of merchandise affixed to the sensor housing and an unsecured state without the item of merchandise affixed to the sensor housing. The display stand further includes an alarm having an unarmed states and an armed state for monitoring the secured state and the unsecured state of the proximity sensor.

### BRIEF DESCRIPTION OF THE DRAWINGS

The present invention is better understood with reference to the following detailed description in conjunction with the accompanying drawing figures.

FIG. 1 is an exploded perspective view of a merchandise display stand and a removable label holder according to the present invention showing the label holder removed from the display stand.

FIG. 2 is an exploded perspective view of the merchandise display stand and removable label holder of FIG. 1 showing an item of merchandise to be affixed to the display stand.

FIG. 3 is a perspective view of the merchandise display stand and removable label holder of FIG. 1 showing the removable label holder mounted on the display stand and the item of merchandise affixed to the display stand.

FIG. 4 is a front right perspective view of a removable label holder according to the present invention.

FIG. 5 is a top view of the label holder of FIG. 4.

FIG. 6 is a front view of the label holder of FIG. 4.

FIG. 7 is a right side view of the label holder of FIG. 4, the left side view being essentially identical in all relevant respects.

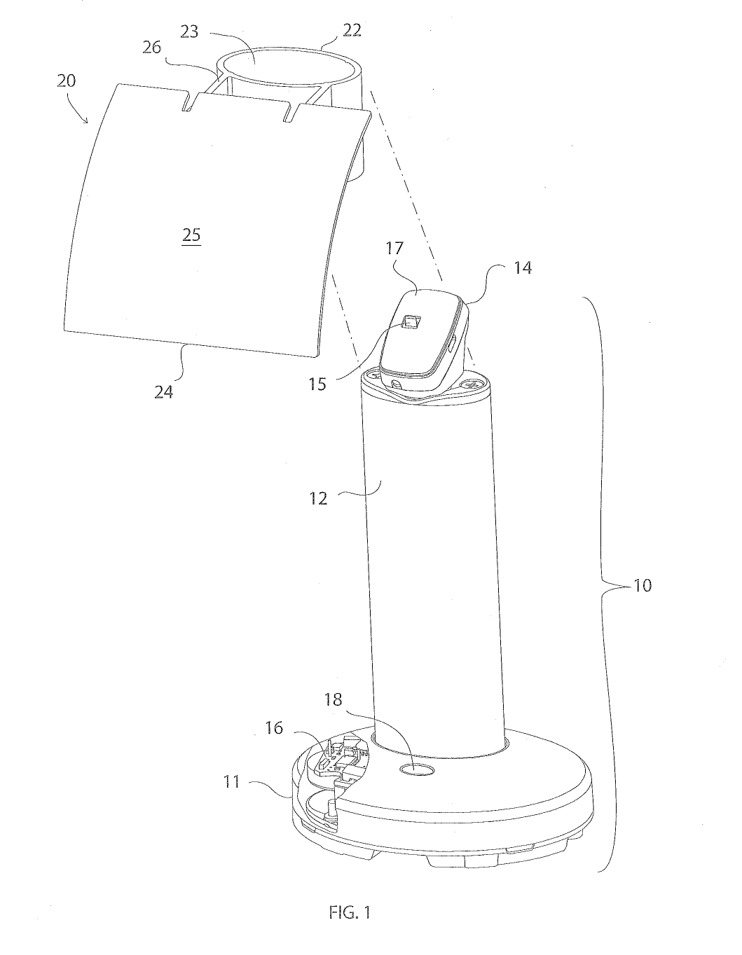

### DETAILED DESCRIPTION OF THE INVENTION

Referring now to the accompanying drawing figures wherein identical reference numerals denote like elements throughout the various views, a merchandise display stand, indicated generally at 10, and removable label holder, indicated generally at 20, according to the present invention are shown. The merchandise display stand 10 is configured for displaying an item of merchandise, indicated generally at 30, such that the merchandise is available to be closely examined, and in many instances, manipulated by a potential purchaser. For example, a potential purchaser may desire to operate the various features of a camera, digital video recorder or cellular telephone when comparing different manufacturers or various models. In preferred embodiments, the label holder 20 is configured to be removably positioned, referred to herein as “mounted,” on the merchandise display stand 10 and prevented from being removed from the display stand while the merchandise 30 is affixed to the display stand, as will be described.

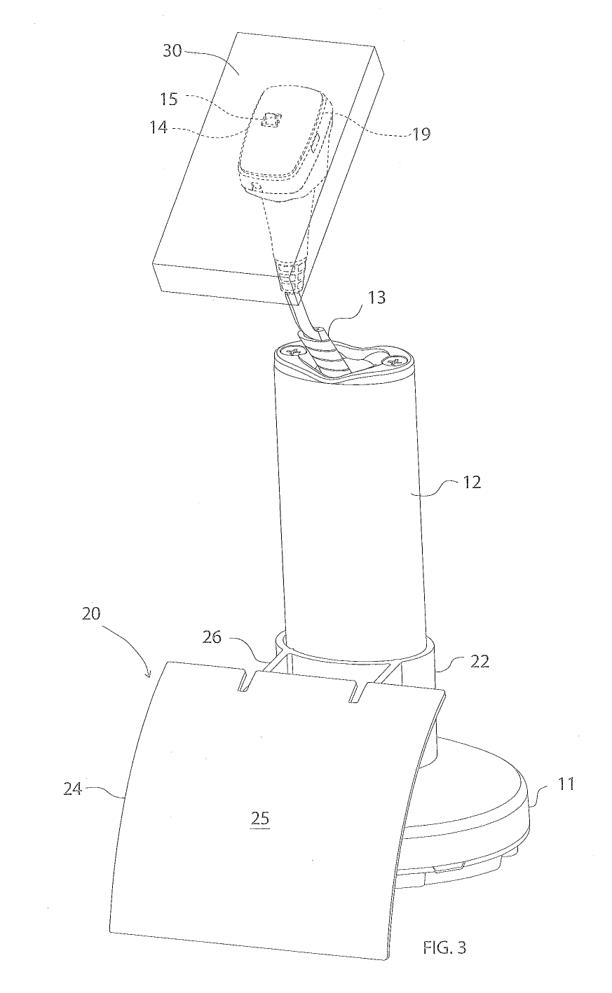

The merchandise display stand 10 comprises a base 11 for receiving the label holder 20. The base 11 may be rigidly secured to a display support, such as a horizontal countertop display or a vertical wall display, by mechanical fasteners and/or adhesive. As shown, the base 11 has an upright portion 12 that depends upwardly (or outwardly) from the base. If secured to a display support, the base 11 may also be provided with a proximity sensor (not shown) that activates an alarm 16 if the base becomes detached from the display support. The display stand 10 further comprises a sensor housing 14 that is movably attached to the base 11 and supported on the upright portion 12. The sensor housing 14 may be attached to the base 11 by a mechanical tether. Preferably, however, the sensor housing 14 is attached to the base 11 by a conductive tether 13 (FIG. 3) that electrically couples a proximity sensor 15 disposed within the sensor housing to the alarm 16 disposed within the base 11. As is well known in the art, the alarm 16 is activated if a conductive loop between the proximity sensor 15 and the alarm 16 is interrupted or the tether 13 is severed while the alarm is armed. The tether 13 is preferably relatively flexible and/or extensible to permit a potential purchaser to readily examine and manipulate the item of merchandise 30. In addition, the tether 13 may be retractable and stored within the base 11 or on a reel (not shown) disposed within the base 11 or beneath the display support. An opening, recess or port 18 may also be provided for arming and disarming the alarm 16. For example, the port 18 may be configured to receive a mechanical or magnetic key, or a radio frequency (RF), infrared (IR) or electromagnetic pulse or signal for communicating with an electronic monitoring circuit in a known manner.

As shown, the removable label holder 20 comprises a mounting portion 22 for engaging the base 11 of the display stand 10 and a label holding portion 24 depending outwardly from the mounting portion. The base 11 of the display stand 10 has an exterior contour and the mounting portion 22 of the label holder 20 has an interior contour that is complimentary to the exterior contour of the base. As used herein, the term “complimentary” is intended to include an interior contour of the mounting portion 22 that conforms generally to the exterior contour of the base 11 sufficiently such that the label holder 20 is prevented from being removed from the base while an item of merchandise 30 is affixed to the display stand 10. In preferred embodiments, the interior contour of the mounting portion 22 of the label holder 20 is complimentary to and just slightly larger than the exterior contour of the upright portion 12 of the base 11, for example in a loose or loose-interference fit, so that the label holder may be placed over the upright portion and positioned onto the base disposed on the display support. The mounting portion 22 defines a central opening 23 sized and generally shaped to receive the upright portion 12 of the base 11.

Regardless, the opening 23 of the mounting portion 22 is configured to permit the label holder 20 to be passed over the sensor housing 14 and onto the upright portion 12 of the base 11 before the merchandise 30 is affixed to the sensor housing. More particularly, the opening 23 is sized equally or larger than the outer periphery of the upright portion 12 of the base 11 and smaller than an outer periphery of the item of merchandise 30 affixed to the display stand 10 so that the label holder 20 cannot be passed back over the item of merchandise. As a result, the label holder 20 is prevented from being removed from the upright portion 12 of the base 11 while the merchandise 30 is affixed to the display stand 10. The opening 23 may have any desired shape, for example circular, elliptical or oval, and need not be an entirely closed opening as long as the label holder 20 cannot be removed while the merchandise 30 is affixed to the sensor housing 14 of the display stand 10.

As previously mentioned, the sensor housing 14 of the merchandise display stand 10 houses a proximity sensor 15. The proximity sensor 15 has a secured state and an unsecured state with the proximity sensor being in the secured state with the item of merchandise 30 affixed to a mounting surface 17 provided on the sensor housing 14. The merchandise 30 may be affixed to the mounting surface 17 of the sensor housing 14 using any suitable attachment means. For example, an opening may be formed through the sensor housing 14 for receiving a conventional cable tie or the like (not shown). The cable tie is passed through the opening and then wrapped around the item of merchandise 30 and pulled taut to hold the merchandise against the mounting surface 17. In certain instances, however, the cable tie interferes with the ability of the potential purchaser to operate the item of merchandise 30, for example when the merchandise is a cellular telephone having a movable cover. Accordingly, it is oftentimes preferable for the attachment means to comprise double-sided adhesive tape 19, as indicated by broken lines in FIG. 3. The double-sided adhesive tape 19 affixes the item of merchandise 30 to the mounting surface 17 of the sensor housing 14 without interfering with the operation of the merchandise and without permanently damaging the merchandise.

In preferred embodiments, the proximity sensor 15 comprises an extensible plunger and the proximity sensor is in the secured state with the plunger depressed and is in the unsecured state with the plunger extended. The proximity sensor, however, may be any mechanical, electrical or optical device for determining whether the item of merchandise 30 is in close proximity (i.e. affixed) to the sensor housing 14. Such sensors are well known in the art and form no part of the present invention, except to the extent that the proximity sensor 15 must be sized to be disposed within a sensor housing 14 having an outer periphery that is smaller than the opening 23 of the mounting portion 22 of the label holder 20. Regardless, the proximity sensor 15 is operatively coupled to the alarm 16 and has an armed state such that the alarm is activated if the item of merchandise 30 is detached from the sensor housing 14. The alarm 16 further has an unarmed state in which the alarm is deactivated so that the merchandise 30 can be detached from the sensor housing 14, for example to remove the label holder 20 from the base 11 of the display stand 10, as will be described.

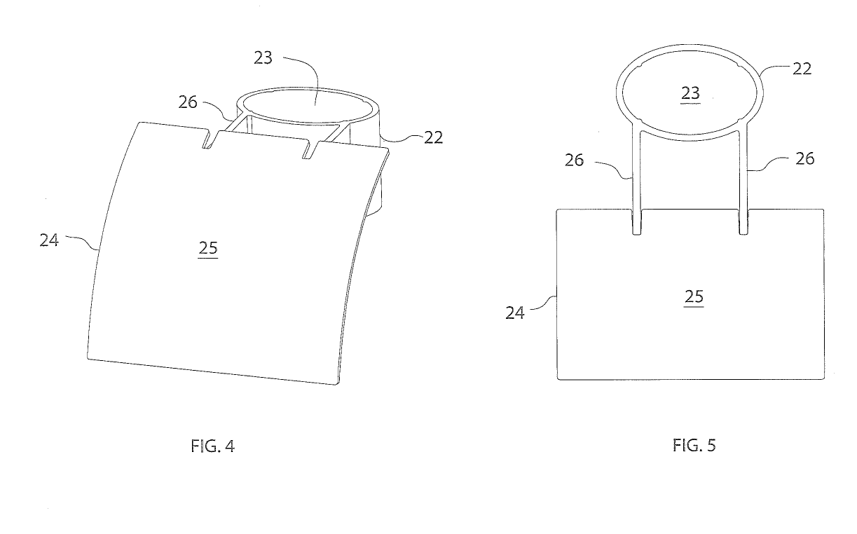

The removable label holder 20 is shown in greater detail in FIGS. 4-7. As shown, the label holder 20 comprises the mounting portion 22 and the label holding portion 24 previously described. The label holder 20 further comprises at least one joining rib 26 extending between the mounting portion 22 and the label holding portion 24 for connecting the label holding portion to the mounting portion. As previously discussed, the mounting portion 22 has an interior contour defining opening 23 that is complimentary to the exterior contour of the upright portion 12 of the base 11 of the display stand 10. The opening 23 is sized such that the mounting portion 22 engages the upright portion 12 of the base 11, but is too small to pass over the item of merchandise 30. In this manner, the mounting portion 22 of the label holder 20 is configured to be removably mounted on the display stand without an item of merchandise 30 affixed to the sensor housing 14 of the display stand 10 and cannot be removed from the display stand while the item of merchandise is affixed to the display stand. In preferred embodiments, the exterior contour of the upright portion 12 of the base 11 and the interior contour of the mounting portion 22 of the label holder 20 are non-circular. In this manner, the label holder 22 is not rotatable about the base 11 and may be positioned in a desired orientation relative to the item of merchandise 30 and/or the base. For example, the port 18 may be disposed between a pair of the joining ribs 26 and obscured by the label holding portion 24 when the label holder 20 is mounted on the base 11.

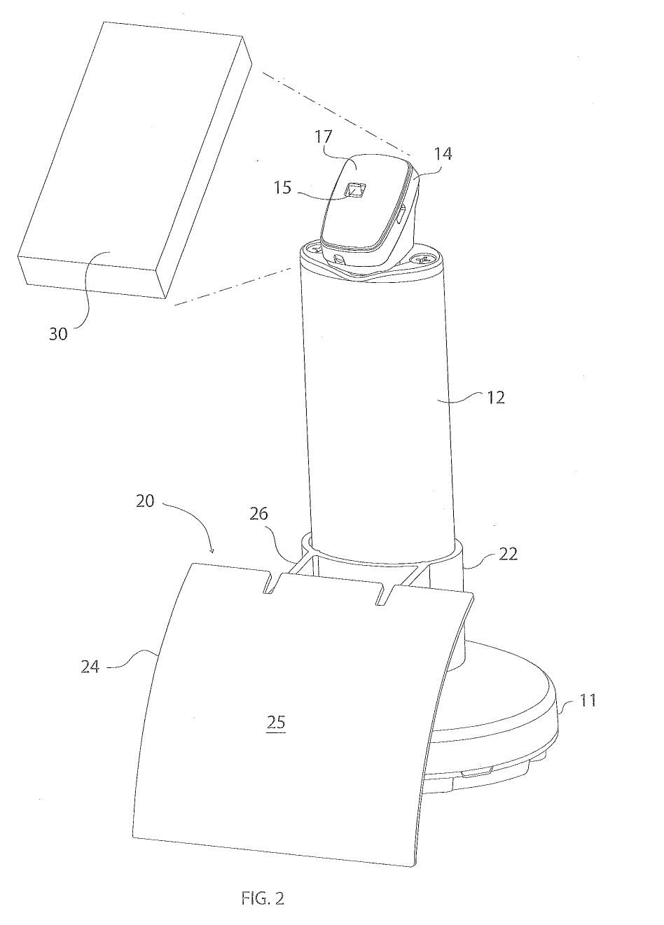

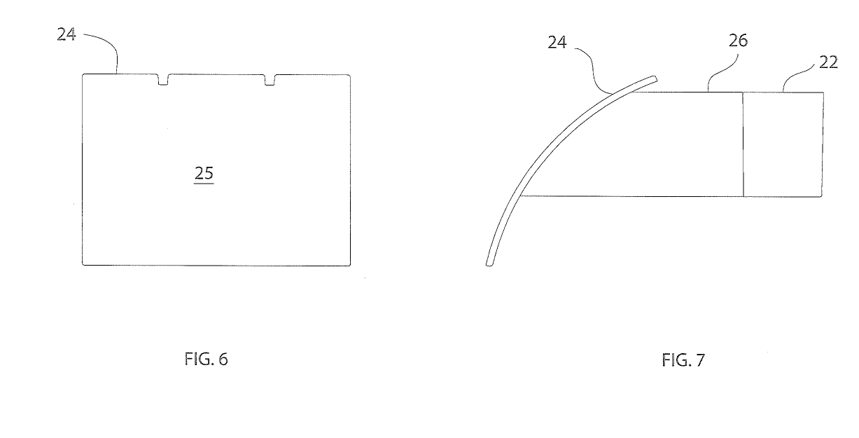

The label holding portion 24 of the label holder 20 defines a surface 25 for receiving a label (not shown) to be observed by a potential purchaser. The surface 25 may be any convenient size suitable for supporting a label on the label holding portion 24. Typically, the label has visual information printed thereon regarding the merchandise, such as a product name, price, description or barcode identifier. The label draws the attention of a potential purchaser to the item of merchandise 30 and may highlight certain features of the merchandise, or indicate the cost and/or other requirements for purchasing the merchandise. The surface 25 may have any desired shape, such as round, square or rectangular. As best shown in FIG. 6 and FIG. 7, the surface 25 is generally rectangular in plan form, but is arcuate (i.e. curved) so as to increase the visibility of the information to the potential purchaser. Alternatively, the surface 25 may be angled relative to the base 11, and if desired, may be positioned at approximately the same angle as the mounting surface 17 of the sensor housing 14. As shown in FIG. 2 and FIG. 3, the curvature or angle of the surface 25 allows the label holding portion 24 to partially obscure the base 11 and permits the label holding portion to rest essentially flush against the surface of the display support. The label may be supported on the surface 25 of the label holding portion 24 in any convenient manner. For example, the label may be disposed within a label holder (not shown) that is releasably clipped to or slid over the label holding portion 24. Alternatively, the label may be affixed to the surface 25 with an adhesive to prevent a malicious individual from removing or replacing the label with a different label from another display stand 10. Regardless, the label holder 20 and label cannot be removed from the base 11 of the display stand 10 while an item of merchandise 30 is affixed to the mounting surface 17 of the sensor housing 14.

The foregoing has described one or more preferred embodiments of a merchandise display stand 10 and a removable label holder 20 for use with the display stand. The label holder 20 is configured to be removably mounted on the display stand 10 and prevented from being removed from the display stand while an item of merchandise 30 is affixed to the display stand. In preferred embodiments, a base 11 of the display stand has an exterior contour and a mounting portion 22 of the label holder 24 has an interior contour that is complimentary to the exterior contour of the base. The label holder 20 is mounted on the display stand 10 and the item of merchandise 30 is thereafter affixed to a sensor housing 14 movably attached to the base 11, for example by a tether 13. An opening 23 defined by the mounting portion 22 is sized to be larger than the periphery of the sensor housing 14, but smaller than the periphery of the item of merchandise 30, such that the label holder 20 cannot be removed from the display stand 10 while the merchandise is affixed to the sensor housing.

While preferred embodiments of the present invention are shown and described herein, it will be readily apparent to those skilled in the art that various modifications can be made thereto without departing from the spirit and scope of the invention. The foregoing description of preferred embodiments of the invention and the best mode for practicing the invention are provided for the purpose of illustration only, and not for the purpose of limitation. In particular, it is envisioned that equivalent embodiments of the invention not specifically disclosed herein are well within the skill of an ordinary artisan without departing from the spirit and scope of the appended claims.

That which is claimed is:

1. A merchandise display stand for displaying an item of merchandise, the display stand comprising:
a base; and
a label holder removably mounted on the base, the label holder having a mounting portion for mounting the label holder on the base and a label holding portion;
wherein the label holder is configured such that the label holder is prevented from being removed from the base while the item of merchandise is displayed on the display stand.

2. The merchandise display stand according to claim 1, wherein the base has an exterior contour and the mounting portion of the label holder has an interior contour defining an opening configured to receive the base.

3. The merchandise display stand according to claim 2 wherein the interior contour of the mounting portion conforms generally to the exterior contour of the base such that the label holder is slidably mounted on the base.

4. The merchandise display stand according to claim 1, further comprising a sensor housing coupled to the base, the sensor housing including a mounting surface for receiving the item of merchandise and attachment means for affixing the item of merchandise to the mounting surface.

5. The merchandise display stand according to claim 4, wherein the base comprises an upright portion for supporting the sensor housing and wherein the mounting portion of the label holder defines an opening configured to pass over the sensor housing and to be received on the upright portion of the base without the item of merchandise affixed to the sensor housing.

6. The merchandise display stand according to 4, wherein the sensor housing comprises a proximity sensor having a secured state and an unsecured state and wherein the proximity sensor is in the secured state with the item of merchandise affixed to the sensor housing and is in the unsecured state without the item of merchandise affixed to the sensor housing.

7. The merchandise display stand according to claim 6, further comprising an alarm operatively coupled to the proximity sensor, the alarm having an unarmed state and an armed state for monitoring the secured state and the unsecured state of the proximity sensor.

8. The merchandise display stand according to claim 1, wherein the label holding portion extends outwardly from the mounting portion and wherein the label holder further comprises at least one joining rib extending between the mounting portion and the label holding portion for connecting the label holding portion to the mounting portion.

9. A merchandise display stand for displaying an item of merchandise comprising:
a base;
a sensor housing coupled to the base, the sensor housing comprising a mounting surface for receiving the item of merchandise and attachment means for affixing the item of merchandise to the mounting surface; and
a label holder configured to be removably mounted on the base and prevented from being removed from the base with the item of merchandise affixed to the sensor housing.

10. A label holder for removably mounting on a base of a display stand, the label holder comprising:
a mounting portion having an interior contour that defines an opening for receiving the base of the display stand; and
a label holding portion extending from the mounting portion.

11. The label holder according to claim 10, wherein the mounting portion is configured to be removably mounted on the display stand without an item of merchandise displayed on the display stand and cannot be removed from the display stand with an item of merchandise displayed on the display stand.

12. The label holder according to claim 10, wherein the base has an exterior contour and the mounting portion of the label holder has a complimentary interior contour defining an opening that conforms generally to the exterior contour of the base such that the label holder is slidably mounted on the base.

13. The label holder according to claim 10, wherein the opening defined by the mounting portion is sized smaller than an outer periphery of an item of merchandise affixed to the display stand such that the label holder cannot be removed from the display stand with the label holder mounted on the display stand and the item of merchandise affixed to the display stand.

14. The label holder according to claim 10, further comprising at least one joining rib extending between the mounting portion and the label holding portion for connecting the label holding portion to the mounting portion.

15. The label holder according to claim 10, wherein the label holding portion defines an arcuate surface for receiving a label having visual information printed thereon.

16. An item of merchandise in combination with a merchandise display stand for displaying the item of merchandise and a removable label holder, comprising:
a merchandise display stand comprising a base and a sensor housing movably attached to the base;
a label holder configured to be removably mounted on the base of the display stand; and
an item of merchandise configured to be affixed to the sensor housing;
wherein the label holder is prevented from being removed from the base of the display stand when the label holder is mounted on the base and the item of merchandise is affixed to the sensor housing.

17. The combination according to claim 16, wherein the base of the display stand has an exterior contour and the label holder has an interior contour that generally conforms to the exterior contour of the base.

18. The combination according to claim 16, wherein the label holder comprises a mounting portion and a label holding portion extending outwardly from the mounting portion and wherein the mounting portion defines an opening sized to receive the base of the display stand.

19. The combination according to claim 18, wherein the opening is sized larger than an outer periphery of the sensor housing and is sized smaller than an outer periphery of the item of merchandise.

20. The combination of claim 16, wherein the sensor housing comprises a proximity sensor having a secured state with the item of merchandise affixed to the sensor housing and an unsecured state without the item of merchandise affixed to the sensor housing and wherein the display stand further comprises an alarm having an unarmed states and an armed state for monitoring the secured state and the unsecured state of the proximity sensor.
